(19) United States
(12) Patent Application Publication
(10) Pub. No.: US 2025/0285415 A1
(43) Pub. Date: Sep. 11, 2025

(54) INFORMATION PROCESSING APPARATUS, INFORMATION PROCESSING METHOD, AND STORAGE MEDIUM

(71) Applicant: NEC Corporation, Tokyo (JP)

(72) Inventor: Shuhei YOSHIDA, Tokyo (JP)

(73) Assignee: NEC Corporation, Tokyo (JP)

(21) Appl. No.: 19/013,038

(22) Filed: Jan. 8, 2025

(30) Foreign Application Priority Data
Mar. 6, 2024 (JP) 2024-034241

(51) Int. Cl. G06V 10/774; G06V 10/762

(52) U.S. Cl. CPC G06V 10/774; G06V 10/762

(57) ABSTRACT

To make operation of generating training data more efficient in machine learning for events in data series. An information processing apparatus includes: a division section that divides, into a plurality of partial feature sets, a set of features constituting a feature series corresponding to each of a plurality of data series; a clustering section that clusters, into a plurality of clusters, a group of the plurality of partial feature sets which has been obtained from the plurality of data series; and a selection section that selects target data to be provided with a ground truth label, from a set of pieces of data which corresponds to at least one of the plurality of partial feature sets included in each of the plurality of clusters and which constitutes at least part of one of the plurality of data series.

### CROSS REFERENCE TO RELATED APPLICATIONS

This application is based upon and claims the benefit of priority from Japanese Patent Application No. 2024-034241 filed on Mar. 6, 2023, the disclosure of which is incorporated herein in its entirety by reference.

### TECHNICAL FIELD

The present disclosure relates to an information processing apparatus, an information processing method, and a storage medium.

### BACKGROUND ART

For training a machine learning model that makes prediction for data series, it is known to use training data in which only some of the pieces of data are provided with ground truth labels, instead of using training data in which all the pieces of data constituting a plurality of data series are provided with ground truth labels.

Selection of data to be provided with a ground truth label from among the pieces of data constituting the plurality of data series is important for generating such training data. For example, Patent Literature 1 discloses a technology for classifying frames constituting a movie into a plurality of clusters on the basis of features of the frames. It is conceivable that frames to be provided with ground truth labels are selected from the clusters into which the frames are classified with use of such a technology.

### CITATION LIST

### Patent Literature

### [Patent Literature 1]

Japanese Patent Application Publication Tokukai No. 2009-60413

### SUMMARY OF INVENTION

### Technical Problem

In a case where the technology disclosed in Patent Literature 1 is used for selecting a frame to be provided with a ground truth label, there has been a problem in that a longer movie has an increased number of frames, resulting in an increase in the calculation cost, since the clustering is carried out on a per frame basis.

The present disclosure has been achieved in light of the foregoing issue, and it is one example object thereof to provide a technology that makes operation of generating training data more efficient in machine learning for events in data series.

### Solution to Problem

An information processing apparatus in accordance with one example aspect of the present disclosure includes at least one processor, the at least one processor carrying out: a division process of dividing, into a plurality of partial feature sets, a set of features constituting a feature series corresponding to each of a plurality of data series; a clustering process of clustering, into a plurality of clusters, a group of the plurality of partial feature sets which has been obtained from the plurality of data series; and a selection process of selecting target data to be provided with a ground truth label, from a set of pieces of data which corresponds to at least one of the plurality of partial feature sets included in each of the plurality of clusters and which constitutes at least part of one of the plurality of data series.

An information processing method in accordance with one example aspect of the present disclosure includes: a division process of dividing, into a plurality of partial feature sets, a set of features constituting a feature series corresponding to each of a plurality of data series; a clustering process of clustering, into a plurality of clusters, a group of the plurality of partial feature sets which has been obtained from the plurality of data series; and a selection process of selecting target data to be provided with a ground truth label, from a set of pieces of data which corresponds to at least one of the plurality of partial feature sets included in each of the plurality of clusters and which constitutes at least part of one of the plurality of data series, the division process, the clustering process, and the selection process being carried out by at least one processor.

A non-transitory storage medium in accordance with one example aspect of the present disclosure stores a program causing at least one processor to carry out: a division process of dividing, into a plurality of partial feature sets, a set of features constituting a feature series corresponding to each of a plurality of data series; a clustering process of clustering, into a plurality of clusters, a group of the plurality of partial feature sets which has been obtained from the plurality of data series; and a selection process of selecting target data to be provided with a ground truth label, from a set of pieces of data which corresponds to at least one of the plurality of partial feature sets included in each of the plurality of clusters and which constitutes at least part of one of the plurality of data series.

### Advantageous Effects of Invention

One example aspect of the present disclosure exerts one example advantage of making it possible to provide a technology that makes operation of generating training data more efficient in machine learning for events in data series.

### BRIEF DESCRIPTION OF DRAWINGS

FIG. 1 is a block diagram illustrating a configuration of an information processing apparatus in accordance with the present disclosure.

FIG. 2 is a flowchart illustrating a flow of an information processing method in accordance with the present disclosure.

FIG. 3 is a block diagram illustrating a configuration of an information processing apparatus in accordance with the present disclosure.

FIG. 4 is a flowchart illustrating a flow of an information processing method in accordance with the present disclosure.

FIG. 5 is a flowchart illustrating a detailed flow of a division process in accordance with the present disclosure.

FIG. 6 is a flowchart illustrating a detailed flow of a division process in accordance with the present disclosure.

FIG. 7 is a view schematically illustrating one example of a screen in accordance with the present disclosure.

FIG. 8 is a block diagram illustrating a hardware configuration of a computer functioning as each apparatus in accordance with the present disclosure.

### EXAMPLE EMBODIMENTS

The following description will discuss example embodiments of the present invention. The present invention is not limited to the example embodiments below, but may be altered in various ways by a skilled person within the scope of the claims. For example, the present invention can also encompass, in its scope, any example embodiment derived by appropriately combining technologies (some or all of the products and methods) employed in the example embodiments described below. Alternatively, the present invention also encompasses, in its scope, any example embodiment derived by appropriately omitting part of a technology employed in the example embodiments described below. The example advantages described in each of the example embodiments below are example advantages expected in that example embodiment, and do not define an extension of the present invention. That is, the present invention also encompasses, in its scope, any example embodiment that does not bring about the example advantages described in the example embodiments below.

### First Example Embodiment

The following description will discuss a first example embodiment, which is an example of an embodiment of the present invention, in detail, with reference to the drawings. The present example embodiment is a basic form of example embodiments described later. Note that the application scope of technologies which are employed in the present example embodiment is not limited to the present example embodiment. That is, technologies employed in the present example embodiment can be employed also in the other example embodiments included in the present disclosure, within a range in which no particular technical problem occurs. Moreover, technologies indicated in the drawings referred to for describing the present example embodiment can be employed also in the other example embodiments included in the present disclosure, within a range in which no particular technical problem occurs.

### (Overview of Information Processing Apparatus 1)

An information processing apparatus 1 is an apparatus configured to select data to be provided with a ground truth label in a plurality of data series in order to generate training data used for training a machine learning model that makes prediction for data series.

The term “data series” refers to a series of pieces of data arranged in order. Examples of the data series include a movie, which is a series of frames arranged in order of time. Examples of the machine learning model that makes prediction for a movie include an action prediction model that predicts an action of a human in a movie. For example, the action prediction model receives a movie as an input, and outputs a class and region of an action of a human contained in the movie as a subject. The information processing apparatus 1 can, for example, generate a plurality of movies in which only some of the frames are provided with action labels, as training data used for training such an action prediction model.

Further, other examples of the data series include a series of pieces of audio data arranged in order of time. Examples of a machine learning model that makes prediction for an audio data series include an audio event prediction model that predicts an audio event in an audio data series. For example, the audio event prediction model receives an audio data series as an input, and outputs a class and region of an audio event contained in the audio data series. The information processing apparatus 1 can, for example, generate a plurality of audio data series in which only some of the pieces of audio data are provided with audio event labels, as training data used for training such an audio event prediction model.

### (Configuration of Information Processing Apparatus 1)

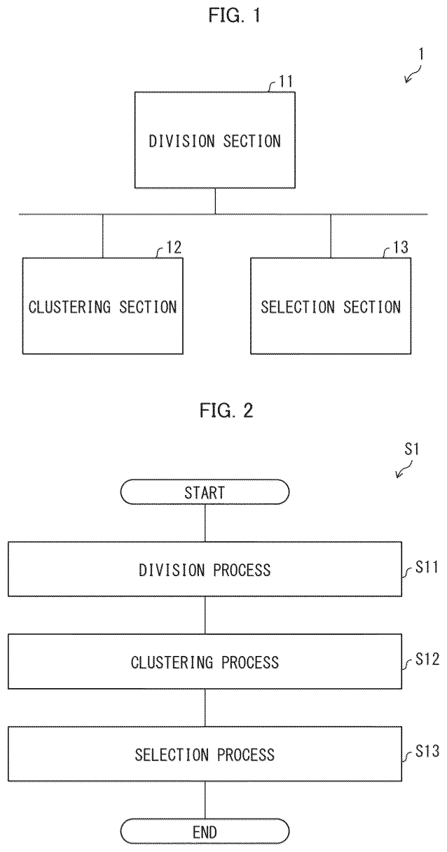

With reference to FIG. 1, the following description will discuss a configuration of an information processing apparatus 1. FIG. 1 is a block diagram illustrating a configuration of the information processing apparatus 1. As illustrated in FIG. 1, the information processing apparatus 1 includes a division section 11, a clustering section 12, and a selection section 13. The division section 11, the clustering section 12, and the selection section 13 are example configurations for achieving division means, clustering means, and selection means, respectively. For example, in a case where the information processing apparatus 1 is constituted by a computer including at least one processor, the division section 11, the clustering section 12, and the selection section 13 are implemented by the at least one processor executing a program.

The division section 11 divides a set of features constituting a feature series corresponding to each of a plurality of data series, into a plurality of partial feature sets. The division process is carried out so that all the features included in the plurality of partial feature sets cover the features constituting the original feature series without excess or deficiency. Here, the feature series represents a feature of the corresponding data series. For example, the feature series may be a series in which the features of the pieces of data which constitute the corresponding data series are arranged in order of the pieces of original data of the data series. In this case, the pieces of data constituting the data series correspond one-to-one to the features constituting the feature series. As another example, the feature series may be a series of features obtained by a convolution process on the corresponding data series. In this case, there is a possibility that the number of pieces of data constituting the feature series is smaller than the number of pieces of data constituting the data series.

For example, the division section 11 may divide a set of features constituting a feature series into a plurality of partial feature sets while maintaining an arrangement of the features of the feature series. For example, the following will take, as an example, a feature series in which a first feature, a second feature, a third feature, a fourth feature, and a fifth feature are arranged in this order. In this example, the division section 11 may divide the set of the first to fifth features of the feature series, while maintaining this order, into a first partial feature set including the first and second features and a second partial feature set including the third to fifth features.

Alternatively, the division section 11 may divide a set of features constituting a feature series into a plurality of partial feature sets, while not necessarily maintaining the order of the features of the feature series. For example, in the example described above, the division section 11 may divide the set of the first to fifth features constituting the feature series, while not necessarily maintaining this order, into a first partial feature set including the first, third, and fourth features and a second partial feature set including the second and fifth features.

As another example of the division process carried out by the division section 11, the division section 11 may randomly divide a set of features constituting a feature series or may divide a feature series at a regular interval.

The clustering section 12 clusters a group of partial feature sets which has been obtained from the plurality of data series, into a plurality of clusters. The “group of partial feature sets which has been obtained from a plurality of data series” preferably include all the plurality of partial feature sets obtained by dividing the feature series corresponding to each of the plurality of data series. For example, assume that a first partial feature set and a second partial feature set are obtained from a first feature series corresponding to a first data series, and a third partial feature set, a fourth partial feature set, and a fifth partial feature set are obtained from a second feature series corresponding to a second data series. In this case, “a group of partial feature sets which has been obtained from a plurality of data series” includes the first to fifth partial feature sets, and the clustering section 12 clusters the first to fifth partial feature sets. Note, however, that the “group of partial feature sets” may be a group of partial feature sets that satisfy a certain condition, among all of the plurality of partial feature sets.

The selection section 13 selects target data to be provided with a ground truth label from a set of pieces of data which corresponds to at least one partial feature set included in each of the clusters and which constitutes at least part of one of a plurality of data series. For example, the selection section 13 may select one of the partial feature sets included in a cluster in a random manner or on the basis of a predetermined condition. The number of the partial feature sets to be selected may be one in each cluster or may be two or more in each cluster. The number of the partial feature sets to be selected may be the same among all the clusters. Alternatively, the number of the partial feature sets to be selected in at least one cluster may be different from the number of the partial feature sets to be selected in another at least one cluster.

Further, the selection section 13 specifies a set of pieces of data which corresponds to the partial feature set selected and which constitutes at least part of one of the plurality of data series. For example, in a case where pieces of data constituting a data series correspond one-to-one to features constituting a feature series, a set of pieces of data corresponding to the features included in the partial feature set selected is specified. In a case where pieces of data constituting a data series do not correspond one-to-one to features constituting a feature series, the corresponding set of pieces of data is specified by reversely tracking the process of converting the data series into the feature series, on the basis of the features included in the partial feature set selected. For example, in a case where the feature series is obtained by a convolution process on a data series, the corresponding set of pieces of data is specified by reversely tracking the convolution process from the features included in the partial feature set selected.

Further, the selection section 13 may select data as target data to be provided with a ground truth label, from a set of pieces of data corresponding to the partial feature set selected, for example, in a random manner or on the basis of a predetermined condition. The number of the pieces of data to be selected may be one for each partial feature set selected or may be two or more for each partial feature set selected. The number of the pieces of data to be selected may be the same among all the partial feature sets selected. Alternatively, the number of the pieces of data to be selected in at least one partial feature set may be different from the number of pieces of data to be selected in another at least one partial feature set.

### (Example Advantage of Information Processing Apparatus)

As such, a configuration is employed in which the information processing apparatus 1 includes the division section 11, the clustering section 12, and the selection section 13 which are described above. As described above, the calculation cost for clustering a group of partial feature sets which has been obtained from a plurality of data series is reduced as compared with a case of clustering all the features which have been obtained from the plurality of data series. Further, it can be said that a set of pieces of data corresponding to a partial feature set included in each cluster is classified into the cluster on the basis of the features of the pieces of data. Thus, it can be expected that data selected from a set of pieces of data corresponding to one of the partial feature sets included in each of the clusters is data representative of pieces of data having features similar among all the plurality of data series. Such a plurality of data series in which only some of pieces of data are provided with ground truth labels are useful as training data for accurate machine learning for events in a data series. As a result, the information processing apparatus 1 has an example advantage of making it possible to make operation of generating training data more efficient in machine learning for events in data series.

### (Flow of Information Processing Method S1)

The information processing method S1 is carried out by at least one processor. For example, in a case where the information processing apparatus 1 described above is constituted by a computer including at least one processor, the information processing apparatus 1 carries out the information processing method S1. With reference to FIG. 2, the following description will discuss a flow of an information processing method S1. FIG. 2 is a flowchart illustrating a flow of the information processing method S1. As illustrated in FIG. 2, the information processing method S1 includes a division process S11, a clustering process S12, and a selection process S13.

In the division process S11, at least one processor (for example, the division section 11) divides a set of features constituting a feature series corresponding to each of a plurality of data series, into a plurality of partial feature sets.

In the clustering process S12, at least one processor (for example, the clustering section 12) clusters a group of the partial feature sets which has been obtained from the plurality of data series, into a plurality of clusters.

In the selection process S13, at least one processor (for example, the selection section 13) selects target data to be provided with a ground truth label from a set of pieces of data which corresponds to at least one partial feature set included in each of the clusters and which constitutes at least part of one of the plurality of data series.

The details of the processes of the division process S11, the clustering process S12, and the selection process S13 are the same as those described for the division section 11, the clustering section 12, and the selection section 13, and thus the detailed descriptions thereof are not repeated.

### (Example Advantage of Information Processing Method S1)

As described above, a configuration is employed in which the information processing method S1 includes the division process S11, the clustering process S12, and the selection process S13 which are described above. Thus, the information processing method S1 provides the same example advantage as that of the information processing apparatus 1.

### Second Example Embodiment

The following description will discuss a second example embodiment, which is an example of an embodiment of the present invention, in detail, with reference to the drawings. The same reference numerals are given to constituent elements having the same functions as those described in the foregoing example embodiment, and descriptions of such constituent elements are omitted as appropriate. Note that the application scope of technologies which are employed in the present example embodiment is not limited to the present example embodiment. That is, technologies employed in the present example embodiment can be employed also in the other example embodiments included in the present disclosure, within a range in which no particular technical problem occurs. Moreover, technologies indicated in the drawings referred to for describing the present example embodiment can be employed also in the other example embodiments included in the present disclosure, within a range in which no particular technical problem occurs.

### (Configuration of Information Processing Apparatus 1A)

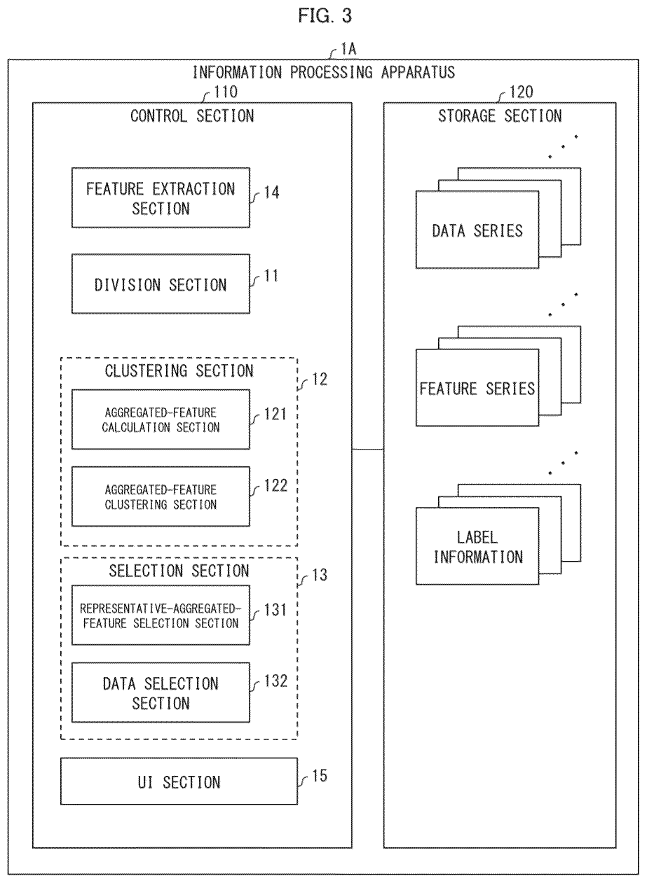

An information processing apparatus 1A can be, for example, used for generating training data used in weak label learning. The weak label learning is machine learning that is carried out with use of training data in which only some of the pieces of data are provided with ground truth labels. However, the training data generated with use of the information processing apparatus 1A is not limited to use for weak label learning. With reference to following description will discuss a configuration E the information processing apparatus 1A. FIG. 3 is a block diagram illustrating a configuration of the information processing apparatus 1A. The information processing apparatus 1A includes a control section 110 and a storage section 120. The control section 110 carries out overall control of the sections of the information processing apparatus 1A. In a case where the information processing apparatus 1A is constituted by a computer, the control section 110 is implemented by, for example, at least one processor included in the computer executing a program.

The storage section 120 stores a program for causing the control section 110 to function and various pieces of data to be used by the control section 110. In a case where the information processing apparatus 1A is constituted by a computer, the storage section 120 is, for example, constituted by a memory included in the computer.

The storage section 120 stores a plurality of data series, a plurality of pieces of label information, and a plurality of feature series. The plurality of data series are targets to be provided with ground truth labels for being used as training data, and are referred to in an information processing method S1A described later. The plurality of feature series are each temporal information generated while the information processing method S1A described later is being carried out. The plurality of pieces of label information are pieces of information indicating some pieces of data of the plurality of data series and ground truth labels provided to the pieces of data, and are generated through the information processing method S1A described later. That is, the plurality of data series and the plurality of pieces of label information are one example of “training data used in weak label learning”. Note that some or all of the plurality of data series may not necessarily be stored in the storage section 120 of the own apparatus, and, for example, may be read from another apparatus connected via a network, a storage medium, or the like.

For example, the following description will discuss an example in which the data series is a movie. In this case, the plurality of data series and the plurality of pieces of label information that are stored in the storage section 120 are indicated by the following formula (1).

$${\{ ( {V}_{n} , {L}_{n} ) \}}_{n = 1}^{N} \qquad ( 1 )$$

In Formula (1), V_n represents a movie, and L_n represents label information corresponding to V_n. N, which represents a natural number of 2 or more, represents the number of movies. n is an index for identifying a movie. Note that in the present specification, a character such as “n” in a subscript notation is also described as, for example, “_n”, with use of the under bar “_”. That is, Formula (1) indicates N pairs of the movies V_n and pieces of label information L_n. Note that before the information processing method S1A is carried out, the storage section 120 stores V_n and does not store L_n. L_n is stored by carrying out the information processing method S1A. The movie V_n is indicated by the following formula (2).

$$( {f}_{n 1} , {f}_{n 2} , ... , {f}_{{nT}_{n}} ) \qquad ( 2 )$$

In Formula (2), f_nt (t=1, 2, . . . , T_n) represents the frames (one example of data) constituting the movie V_n. The frame f_nt is typically an array of pixels represented by RGB values. T_n, which represents a natural number of not less than 2, represents the number of the frames constituting the movie V_n. That is, Formula (2) indicates a frame series (one example of data series) in which T_n frames are arranged in order of n1, n2, . . . , nT_n.

The control section 110 includes a feature extraction section 14 and a user interface (UI) section 15 in addition to the division section 11, the clustering section 12, and the selection section 13 which are included in the information processing apparatus 1. The UI section 15 is one example of a configuration for achieving user interface means.

The feature extraction section 14 generates a feature series by extracting features from each of a plurality of data series. The feature series is a series of features indicating a feature of the data series. For example, the feature extraction section 14 generates a feature series indicated in the following formula (3) by extracting features from the frame series indicated in Formula (2) which corresponds to the movie V_n in Formula (1).

$$( {z}_{n 1} , {z}_{n 2} , ... , {z}_{{nS}_{n}} ) \qquad ( 3 )$$

Formula (3), which is one in which a frame series indicated in Formula (2) is converted into a feature series, indicates a series of features z_ns (s=1, 2, . . . , S_n). The feature z_ns is represented typically by a vector. Known techniques can be employed for converting a frame series into a feature series. Here, in a case where a method for converting each frame f_nt into a feature z_ns is employed, the length S_n of the feature series matches the length T_n of the frame series. In a case where another method is employed (for example, in a case where frame series are collectively converted with use of a three-dimensional convolutional neural network (3D-CNN)), S_n may not match T_n.

N feature series indicated in the following formula (4) are obtained by obtaining Formula (3) for each of the N movies V_n.

$${\{ ( {z}_{n 1} , {z}_{n 2} , ... , {z}_{{nS}_{n}} ) \}}_{n = 1}^{N} \qquad ( 4 )$$

The division section 11 has the following configuration in addition to the same configuration as that of the division section 11 included in the information processing apparatus 1. The division section 11 may carry out a division process by a first division method described below, or may carry out a division process by a second division method described blow.

By the first division method, the division section 11 divides each of the plurality of feature series in a local minimum area at which a similarity between adjacent features becomes local minimum and obtains, as partial feature sets, a plurality of parts of the feature series obtained through the division. The local minimum area refers to an area at which a similarity between features included in a predetermined width becomes minimum. For example, the division section 11 may sequentially detect local minimum areas in order from the beginning of the feature series while shifting the predetermined width. It is conceivable that, for example, a negative Euclidean distance or a cosine similarity is used as the similarity.

Note that the division section 11 may detect the local minimum area after smoothing the feature series. Examples of smoothing include, but are not limited to, a process that uses a moving average and a window function. The smoothing may not be necessarily carried out, but the smoothing makes it possible to suppress detection noises of a local minimum area. The width of the window used in smoothing is preferably set to be shorter than a duration time of a ground truth label to be detected by a target prediction model to be trained (for example, in a case where the prediction model is the action prediction model described above, a typical duration time of an action). The partial feature set resulting from the division by the first division method includes features arranged in a consecutive sequence in the original feature series.

In the second division method, the division section 11 divides a set of features constituting a feature series into a plurality of partial feature sets by clustering the set of features. The features included in the partial feature set resulting from the division by the second division method are not necessarily arranged in a consecutive sequence in the original feature series, and may include inconsecutive features.

In either case of the first division method and the second division method, the partial feature set obtained by the division is indicated by the following formula (5).

$$( {z}_{n {σ}_{ni 1}} , {z}_{n {σ}_{ni 2}} , ... , {z}_{n {σ}_{{niJ}_{ni}}} ) \qquad ( 5 )$$

In Formula (5), i, which is an index of the partial feature set, represents an i-th partial feature set among I_n partial feature sets (I_n is a natural number of not less than 2) corresponding to the n-th movie V_n. The i-th partial feature set includes J_ni features. σ_nij indicates that the j-th feature included in the i-th partial feature set corresponds to the σ_nij-th of the feature series indicated in the original formula (3). That is, in a case where for certain n, all σ_nij are collected, n1, n2, . . . , ns_n are covered without excess or deficiency.

A plurality of partial feature sets indicated by Formula (5) are obtained for each of the N feature series indicated by Formula (4), so that a group of partial feature sets represented by the following formula (6) is obtained. The group of partial feature sets indicated by Formula (6) includes the partial feature sets obtained from all of the plurality of movies V_n.

$${\{ ( \begin{matrix}( {z}_{n {σ}_{n 11}} , {z}_{n {σ}_{n 12}} , ... , {z}_{n {σ}_{n 1 {J}_{n 1}}} ) , \\ ( {z}_{n {σ}_{n 21}} , {z}_{n {σ}_{n 22}} , ... , {z}_{n {σ}_{n 2 {J}_{n 2}}} ) , ... , \\ ( {z}_{n {σ}_{{nI}_{n} 1}} , {z}_{n {σ}_{{nI}_{n} 2}} , ... , {z}_{n {σ}_{{nI}_{{nJ}_{{nI}_{n}}}}} )\end{matrix} ) \}}_{n = 1}^{N} \qquad ( 6 )$$

The clustering section 12 has the following configuration in addition to the same configuration as that of the clustering section 12 included in the information processing apparatus 1. The clustering section 12 includes an aggregated-feature calculation section 121 and an aggregated-feature clustering section 122.

The aggregated-feature calculation section 121 calculates, for each of the partial feature sets of the group of the partial feature sets, a collective feature indicating the partial feature set. Here, the “collective feature” may be a feature into which the features included in the partial feature set are aggregated. The term “aggregate” means to convert one or more features into one feature. Hereinafter, the “collective feature” is also referred to as “aggregated feature”. For example, the aggregated-feature calculation section 121 may calculate, as the aggregated feature, an average of the features (for example, z_n_σ_nij, j=1, 2, . . . . J_ni indicated in Formula (5)) included in one partial feature set. As another example, the aggregated-feature calculation section 121 may calculate the aggregated feature by carrying out the max pooling for each dimension of the features included in one partial feature set. In a case where the feature is represented by a vector, the aggregated feature is also represented by a vector.

By calculating an aggregated feature for each of the partial feature sets included in the group of the partial feature sets indicated by Formula (6), a group of aggregated features indicated by the following formula (7) is obtained.

$${\{ ( {\tilde{z}}_{n 1} , {\tilde{z}}_{n 2} , ... , {\tilde{z}}_{{nI}_{n}} ) \}}_{n = 1}^{N} \qquad ( 7 )$$

In Formula (7), z\hat{ }_ni represents an aggregated feature calculated from the i-th partial feature set corresponding to the movie V_n. Note that in the present specification, a tilde above a character such as “z” is also described as, for example, “z\hat{ }”, with use of the hat “\hat{ }”

Further, the aggregated-feature clustering section 122 clusters a group of partial feature sets into a plurality of clusters by clustering a plurality of aggregated features. For example, the aggregated-feature clustering section 122 carries out the clustering through a known method, such as K-Means and BIRSH. For example, the number G of the clusters (hereinafter, also referred to as “cluster number G”) is preferably set so that a time period during which the clustering is carried out falls within an allowable range.

For example, by clustering the group of aggregated features represented by Formula (7), the following formula (8) is obtained as a result of the clustering.

$${\{ ( {g}_{n 1} , {g}_{n 2} , ... , {g}_{{nI}_{n}} ) \}}_{n = 1}^{N} \qquad ( 8 )$$

In Formula (8), g_ni represents identification information of a cluster to which the aggregated feature z\hat{ }_ni belongs, among the G clusters. It can be said that the cluster g_ni is a cluster to which the original “partial feature set” from which the aggregated feature z\hat{ }_ni has been calculated belongs.

The selection section 13 has the following configuration in addition to the same configuration as that of the selection section 13 included in the information processing apparatus 1. The selection section 13 includes a representative-aggregated-feature selection section 131 and a data selection section 132.

The representative-aggregated-feature selection section 131 selects, on the basis of the aggregated features, one of the partial feature sets included in each of the clusters, as a partial feature set corresponding to a set of pieces of data from which target data to be provided with a ground truth label is to be selected. The representative-aggregated-feature selection section 131 may select, on the basis of the number of the plurality of clusters and of the number of pieces of the data to be provided with the ground truth label, one of the partial feature sets included in each of the plurality of clusters, as the partial feature set corresponding to the set of pieces of data from which the target data to be provided with the ground truth label is to be selected.

Here, the expression “partial feature sets included in each of clusters” refers to “original partial feature sets from which aggregated features included in each of clusters which have been obtained by clustering the aggregated features have been calculated”. In other words, the representative-aggregated-feature selection section 131 selects one of the aggregated features included each of the clusters to select the corresponding one of the partial feature sets. Hereinafter, the aggregated feature selected by the representative-aggregated-feature selection section 131 is also referred to as “representative aggregated feature”.

Note that as described above, the cluster number G is preferably set so that a time period during which the clustering is carried out falls within an allowable range. The number K of pieces of target data to be provided with ground truth labels is preferably set on the basis of a man-hour of a user who provides the ground truth labels. Hereinafter, the “target data to be provided with a ground truth label” is also referred to as “provision target data”. The number K of pieces of provision target data is also referred to as “provision target data number K”. The provision target data number K is represented by, for example, the following formula (9).

$$K = {\sum }_{n = 1}^{N} {K}_{n} \qquad ( 9 )$$

In Formula (9), K_n represents the number of frames to be provided with ground truth labels for the movie V_n. In order to provide ground truth labels y_nk to only some of the frames of the movie V_n, a value smaller than T_n is preferably set as K_n. That is, the provision target data number K is the total number of the frames to be provided with ground truth labels in all the plurality of movies V_n. Note that the provision target data number K is preferably set to a value equal to or greater than the cluster number G.

For example, the representative-aggregated-feature selection section 131 may select K/G representative aggregated features from each of the clusters. Note that “K/G” means a natural number obtained by dividing K by G and rounding down the quotient. The representative-aggregated-feature selection section 131 may, for example, randomly select K/G representative aggregated features in each of the clusters. In a case where the cluster number G and the provision target data number K are equal, K/G=1. The representative-aggregated-feature selection section 131 thus selects one representative aggregated feature in each of the clusters. In this case, the representative-aggregated-feature selection section 131 may select, as the representative aggregated feature, an aggregated feature closest to the center of a feature space in each of the clusters. In a case where the cluster number G is smaller than the provision target data number K, the representative-aggregated-feature selection section 131 may cluster aggregated features belonging to each of the clusters into K/G partial clusters and select an aggregated feature closest to the center of a feature space in each partial cluster as the representative aggregated feature.

The data selection section 132 specifies a set of pieces of data of at least part of one of a plurality of data series which corresponds to the representative aggregated feature. Further, the data selection section 132 selects target data to be provided with a ground truth label from the specified set of pieces of data. For example, the data selection section 132 specifies the original partial feature set from which the representative aggregated feature has been calculated. Further, the data selection section 132 specifies a set of pieces of data which corresponds to the partial feature set specified and which constitutes at least part of one of the plurality of data series. Specific examples of the set of pieces of data corresponding to the partial feature set are as described in the first example embodiment, and thus, the details thereof are not repeated. In a case where the set of pieces of data specified is arranged in a consecutive sequence in the original data series (i.e., is a partial data series), the data selection section 132 may select one of the pieces of data on the basis of the order of the sequence. For example, the data selection section 132 may select data at the center of the partial data series. In contrast, in a case where the set of pieces of data specified are not arranged in a consecutive sequence in the original data series, the data selection section 132 may randomly select data from the set of pieces of data. The data selected by the data selection section 132 is indicated by, for example, the following formula (10).

$${\{ ( {t}_{n 1} , {t}_{n 2} , ... , {t}_{{nK}_{n}} ) \}}_{n = 1}^{N} \qquad ( 10 )$$

In Formula (10), t_nk (k=1, 2, . . . , K_n) represents a frame number (one example of identification information of provision target data) to be provided with a ground truth label in the movie V_n. That is, Formula (10) indicates that K_n provision target frames are selected in each of the N movies V_n.

The UI section 15 receives, from a user, an input of a ground truth label for the data selected by the data selection section 132. For example, in a case where the data series is a movie, the UI section 15 may display, on a display apparatus, a screen including information indicating frames selected by the data selection section 132 and UI objects that each receive an input of a ground truth label for the data. Further, the UI section 15 generates label information for each of a plurality of data series.

For example, each of the plurality of pieces of label information includes a pair of identification information of the data and a ground truth label of the data. The label information may not be stored in the storage section 120 before the information processing method S1A described later is carried out, and is stored in the storage section 120 by carrying out the information processing method S1A. Note that some or all of the plurality of pieces of label information may not be necessarily stored in the storage section 120 of the own apparatus, and, for example, may be stored in another apparatus connected via a network, a portable storage medium, or the like.

For example, N pieces of label information generated for N movies V_n are indicated by the following formula (11).

$${\{ ( {t}_{nk} , {y}_{nk} ) \}}_{k = 1}^{{K}_{n}} \qquad ( 11 )$$

In Formula (11), y_nk represents a ground truth label provided to a frame with the frame number t_nk which is a provision target frame. Since K_n is smaller than T_n as described above, Formula (11) indicates ground truth labels provided to only some of the frames of the movie V_n. Here, for example, the ground truth label y_nk is indicated by the following formula (12).

$${y}_{nk} ∈ {\{ 0 , 1 \}}^{C} \qquad ( 12 )$$

In Formula (12), C represents the number of classes of the ground truth label. Examples of the ground truth label y_nk include an action class of a human to be predicted in the movie v_n. In this case, C is the number of action classes. y_nk is a vector which has as many dimensions as the class number and whose components each take a value of 0 or 1. If y_nkc=1, it indicates that the action c is occurring in a frame with the frame number t_nk, whereas if y_nkc=0, it indicates that the action c is not occurring in a frame with the frame number t_nk.

### (Information Processing Method S1A)

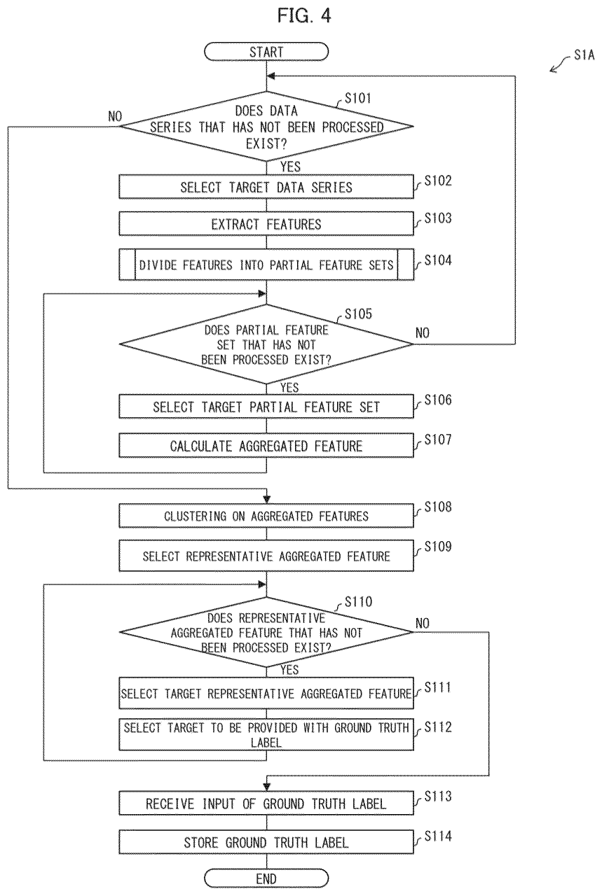

The information processing apparatus 1A configured as above carries out the information processing method S1A. With reference to FIG. 4, the following description will discuss a flow of the information processing method S1A. FIG. 4 is a flowchart illustrating a flow of the information processing method S1A. As illustrated in FIG. 4, the information processing method S1A includes steps S101 to S114. Note that, it is assumed that at the start of the information processing method S1A, a plurality of data series (for example, N movies V_n indicated in Formula (1)) are stored in the storage section 120, and the feature series and the label information have not yet stored in the storage section 120.

In the step S101, the control section 110 determines whether or not a data series that has not been processed exists. The “data series that has not been processed” refers to a data series that has not been subjected to the succession of the processes of the steps S102 to S107, among the plurality of data series stored in the storage section 120. In a case where no data series that has not been processed is found (No in step S101), the step S108 described later is carried out. In a case where the data series that has not been processed is found (Yes in the step S101), the next step S102 is carried out.

In the step S102, the control section 110 selects, as a target data series, one of the data series that have not been processed. The succession of the processes of the steps S103 to S107 is carried out on the target data series. The target data series is, for example, the n-th movie V_n of the N movies V_n.

In the step S103, the feature extraction section 14 extracts features from the target data series to generate a feature series. Thus, for example, the feature series indicated by Formula (3) which corresponds to the target movie V_n is generated.

In the step S104, the division section 11 divides a set of features constituting the feature series into a plurality of partial feature sets. Thus, the I_n partial feature sets indicated in Formula (5) which correspond to the target movie V_n are generated.

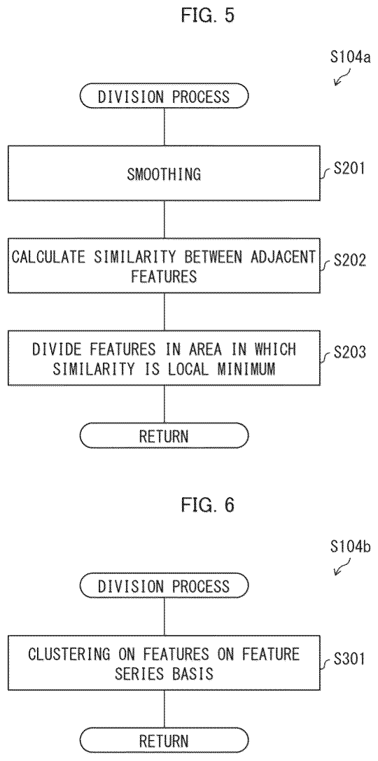

For example, in the step S104, the division section may carry out either a division process S104a illustrated in FIG. 5 or a division process S104b illustrated in FIG. 6.

FIG. 5 is a flowchart illustrating a detailed flow of the division process S104a. As illustrated in FIG. 5, the division process S104a includes steps S201 to S203.

In the step S201, the division section 11 smooths the feature series. In the step S202, the division section 11 calculates a similarity between adjacent features in the feature series smoothed. In the step S203, the division section 11 divides the feature series in a local minimum area in which the similarity is a local minimum, and a plurality of parts of the feature series that have been obtained by the division are regarded as partial feature sets. Note that in the step S203, the partial feature sets may include features after the smoothing or may include features before the smoothing. Thus, the division process S104a is ended.

FIG. 6 is a flowchart illustrating a detailed flow of the division process S104b. As illustrated in FIG. 6, the division process S104b includes a step S301. In the step S301, the division section 11 divides a set of features constituting the feature series into a plurality of partial feature sets by clustering the set of features. Note that the clustering carried out by the division section 11 in the division process S104b is carried out on a per feature series basis. This clustering thus differs from that which is carried out by the clustering section 12 on all the partial feature sets obtained across the plurality of feature series. Thus, the division process S104b is ended.

After the division process S104a or S104b is carried out in the step S104, the step S105 in FIG. 4 is then carried out.

In the step S105, the control section 110 determines whether or not a partial feature set that has not been processed exists. The “partial feature set that has not been processed” refers to a partial feature set that has not been subjected to the succession of the processes of the steps S106 and S107, among the plurality of partial feature sets into which the feature series corresponding to the target data series has been divided. In a case where no partial feature set that has not been processed is found (No in step S105), the succession of the processes on the target data series is ended, and the processes from the step S101 are repeated. In a case where the partial feature set that has not been processed is found (Yes in the step S105), the next step S106 is carried out.

In the step S106, the control section 110 selects, as a target partial feature set, one of the partial feature sets that have not been processed. The process of the next step S107 is carried out on the target partial feature set. The target partial feature set is, for example, an i-th partial feature set of the I_n partial feature sets corresponding to the target movie V_n.

In the step S107, the aggregated-feature calculation section 121 calculates an aggregated feature corresponding to the target partial feature set. Thus, the process on the target partial feature set is ended. Subsequently, the processes from the step S105 are repeated.

In this way, in a case where it is determined, in the step S101, that no data series that has not been processed exists, a group of feature series indicated by Formula (4), a group of partial feature sets indicated by Formula (6), and a group of aggregated features indicated by Formula (7) are obtained across all the N movies V_n, for example. In this case, the next step S108 is carried out.

In the step S108, the aggregated-feature clustering section 122 clusters the plurality of aggregated features. For example, the clustering is carried out on the group of aggregated features indicated by Formula (7). This provides, for example, the clustering result indicated by Formula (8).

In the step S109, the representative-aggregated-feature selection section 131 selects a representative aggregated feature from each of the clusters. For example, as described above, K/G representative aggregated features may be selected in each of the clusters.

In the step 110, the control section 110 determines whether or not a representative aggregated feature that has not been processed exists. The “representative aggregated feature that has not been processed” is a representative aggregated feature that has not been subjected to the succession of the processes of the steps S111 and S112, among the representative aggregated features selected from each of the clusters. In a case where no representative aggregated feature that has not been processed is found (No in step S110), the step S113 described later is carried out. In a case where the representative aggregated feature that has not been processed is found (Yes in the step S110), the next step S111 is carried out.

In the step S111, the control section 110 selects, as a target representative aggregated feature, one of the representative aggregated features that have not been processed. The process of the next step S112 is carried out on the target representative aggregated feature.

In the step S112, the data selection section 132 specifies the original partial feature set from which the target representative aggregated feature has been calculated, and specifies a set of pieces of data of at least part of one of the plurality of data series which corresponds to the partial feature set specified. For example, the set of pieces of data can be specified by reversely tracking Formulas (7), (6), (4), and (2).

Further, in the step S112, the data selection section 132 selects provision target data to be provided with a ground truth label, from the set of pieces of data specified. Thus, a succession of processes on the target representative aggregated feature is ended. Subsequently, the processes from the step S110 are repeated.

Thus, in a case where it is determined, in the step S110, that no representative aggregated feature that has not been processed exists, for example, the pieces of provision target data indicated in Formula (10) which have been selected from all the N movies V_n are obtained. In this case, the next step S113 is carried out.

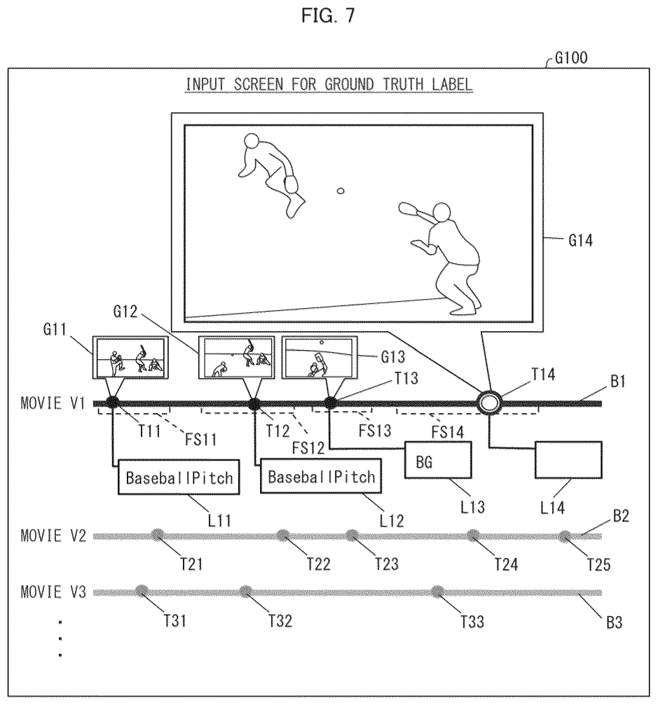

In the step S113, the UI section 15 receives an input of a ground truth label for the provision target data. FIG. 7 is a view schematically illustrating one example of a screen displayed on a display apparatus (not illustrated) in the step S113.

As illustrated in FIG. 7, a screen example G100 is an input screen to provide label information to a plurality of movies V1, V2, and V3. The screen example G100 includes, for the movies V_1, V_2, V_3 . . . , seek bars B1, B2, and B3 corresponding to the lengths of the respective movies; and the symbols T11 to T14, T21 to T25, and T31 to T33 indicating positions of provision target frames. For example, in the screen example G100, the movie V_1 has been selected by the user, and thus the seek bar B1 is displayed with greater emphasis than the seek bars B2 and B3 of the other movies V_2 and V_3. The symbols T11 to T14 on the seek bar B1 show positions of the four provision target frames selected in the movie V_1. The images G11 to G14 show thumbnails of provision target frames indicated by the symbols T11 to T14. The UI objects L11 to L14 are UI objects to which ground truth labels to be provided to the provision target frames indicated by the symbols T11 to T14 are to be inputted. Each of the UI objects L11 to L14 may be, for example, an object that receives an operation of selecting one of C predetermined action classes. The ground truth labels “BaseballPitch”, “BaseballPitch”, and “BG” are already inputted into the UI objects L11 to L13, respectively. The symbol T14 has been selected by the user for input of the ground truth label. The image G14 corresponding to the symbol T14 is thus displayed with greater emphasis than the other images G11 to G13.

The information processing apparatus 1A clusters the group of partial feature sets obtained across all the N movies V_n, so that such a screen example G100 is displayed. This exerts an example advantage of reducing the time taken for the screen example G100 to be displayed from when the movies V_n have been provided to the information processing apparatus 1A, compared with the case where clustering is carried out on the set of all the features included in each of the feature series corresponding to the movies V_n.

### (Variation)

The descriptions in the above-described second example embodiment mainly discuss a case where the data series is a movie. However, the second example embodiment can be applied to a case where training data used in weak label learning is generated from data series other than movies (for example, audio data series). Specific examples of the division process, the clustering process, and the selection process which are described in the example embodiments are not limited to the examples described above. The information processing apparatuses 1 and 1A described in the example embodiments are not limited to being physically constituted by one computer, and may be constituted by a plurality of computers (for example, a server and a terminal).

### (Example Advantages of Present Example Embodiment)

As described above, in the present example embodiment, a configuration is employed of further including the user interface section 15 that receives, from a user, an input of a ground truth label for data selected by the selection section 13. The above configuration makes it possible to assist a user in generating training data used in weak label learning.

In the present example embodiment, a configuration is employed in which the aggregated-feature calculation section 121 calculates respective aggregated features indicating the partial feature sets in the group of partial feature sets, and the aggregated-feature clustering section 122 clusters the aggregated features, so that clustering is carried out on the group of the partial feature set into the plurality of clusters. The above configuration makes it possible to accurately cluster a group of partial feature sets.

In the present example embodiment, a configuration is employed in which the representative-aggregated-feature selection section 131 selects, on the basis of the aggregated features, one of the partial feature sets included in each of the clusters, as the partial feature set corresponding to a set of pieces of data from which the target data to be provided with the ground truth label is to be selected. The above configuration makes it possible to more accurately select partial feature sets included in the plurality of clusters. embodiment, In the present example a configuration is employed in which the division section 11 divides the set of features constituting the feature series into the plurality of partial feature sets by clustering the set of features. The above configuration makes it possible to accurately divide a feature series without being limited by an arrangement of the original feature series.

In the present example embodiment, a configuration is employed in which the representative-aggregated-feature selection section 131 selects, on the basis of the number of the plurality of clusters and of the number of pieces of the target data to be provided with the ground truth label, one of the partial feature sets included in each of the clusters, as the partial feature set corresponding to the set of pieces of data from which the target data to be provided with the ground truth label is to be selected. The above configuration makes it possible to select a more appropriate number of pieces of provision target data, considering both a calculation cost for clustering the partial feature sets and time and effort of a user for providing a ground truth label to provision target data.

### [Software Implementation Example]

Some or all of the functions of each of the information processing apparatuses 1 and 1 A (hereinafter, also referred to as “each apparatus above”) may be implemented by hardware such as an integrated circuit (IC chip), or may be implemented by software.

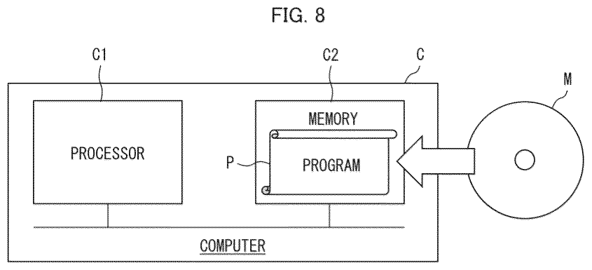

In the latter case, each apparatus above is implemented by, for example, a computer that executes instructions of a program that is software implementing the foregoing functions. FIG. 8 illustrates an example of such a computer (hereinafter, referred to as “computer C”). FIG. 8 is a block diagram illustrating a hardware configuration of the computer C which functions as each apparatus above.

The computer C includes at least one processor C1 and at least one memory C2. The memory C2 stores a program P for causing the computer C to operate as each apparatus above. The processor C1 of the computer C retrieves the program P from the memory C2 and executes the program P, so that the functions of each apparatus above are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded in a case where the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communications network, a broadcast wave, or the like. The computer C can obtain the program P also via such a transmission medium.

The above functions of each apparatus above may be implemented by a single processor provided in a single computer, or may be implemented by a plurality of processors provided in a single computer working together, or may be implemented by a plurality of processors provided in a respective plurality of computers working together. The program for causing each apparatus above to carry out the above-described functions may be stored in a single memory provided in a single computer, or may be stored dispersedly in a plurality of memories provided in a single computer, or may be stored dispersedly in a plurality of memories provided in a respective plurality of computers.

### [Additional Remark 1]

The present disclosure encompasses techniques described in the supplementary notes below. Note, however, that the present invention is not limited to the techniques described in the supplementary notes below, but may be altered in various ways by a skilled person within the scope of the claims.

### (Supplementary Note 1)

An information processing apparatus including:
division means that divides a set of features constituting a feature series corresponding to each of a plurality of data series;
clustering means that clusters, into a plurality of clusters, a group of the plurality of partial feature sets which has been obtained from the plurality of data series; and
selection means that selects target data to be provided with a ground truth label from a set of pieces of data which corresponds to at least one of the plurality of partial feature sets included in each of the plurality of clusters and which constitutes at least part of one of the plurality of data series.

### (Supplementary Note 2)

The information processing apparatus according to supplementary note 1, further including user interface means that receives, from a user, an input of the ground truth label for the target data selected by the selection means.

### (Supplementary Note 3)

The information processing apparatus according to supplementary note 1 or 2, wherein the clustering means clusters the group of the plurality of partial feature sets into the plurality of clusters by calculating respective collective features indicating the plurality of partial feature sets in the group of the plurality of partial feature sets and clustering the collective features.

### (Supplementary Note 4)

The information processing apparatus according to supplementary note 3, wherein the selection means selects, based on the collective features, one of the plurality of partial feature sets included in each of the plurality of clusters, as the at least one of the plurality of partial feature sets which corresponds to the set of pieces of data from which the target data to be provided with the ground truth label is to be selected.

### (Supplementary Note 5)

The information processing apparatus according to any one of supplementary notes 1 to 4, wherein the division means divides the set of features constituting the feature series into the plurality of partial feature sets by clustering the set of features.

### (Supplementary Note 6)

The information processing apparatus according to any one of supplementary notes 1 to 5, wherein the selection means selects, based on the number of the plurality of clusters and on the number of pieces of the target data to be provided with the ground truth label, one of the plurality of partial feature sets included in each of the plurality of clusters, as the at least one of the plurality of partial feature sets which corresponds to the set of pieces of data from which the target data to be provided with the ground truth label is to be selected.

### (Supplementary Note 7)

An information processing method comprising:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series,
the division process, the clustering process, and the selection process being carried out by at least one processor.
   (Supplementary Note 8) A program causing at least one processor to carry out:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series.

### (Supplementary Note 9)

An information processing apparatus including at least one processor, the at least one processor carrying out:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series.

The information processing apparatus may further include a memory. In the memory, a program for causing the at least one processor to carry out the processes can be stored.

### Reference Signs List

1, 1A Information processing apparatus
11 Division section
12 Clustering section
13 Selection section
14 Feature extraction section
15 User interface section
110 Control section
120 Storage section
121 Aggregated-feature calculation section
122 Aggregated-feature clustering section
131 Representative-aggregated-feature selection section
132 Data selection section

1. An information processing apparatus comprising at least one processor, the at least one processor carrying out:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series.

2. The information processing apparatus according to claim 1, wherein the at least one processor further carries out a user interface process of receiving, from a user, an input of the ground truth label for the target data selected in the selection process.

3. The information processing apparatus according to claim 1, wherein in the clustering process, the at least one processor clusters the group of the plurality of partial feature sets into the plurality of clusters by calculating respective collective features indicating the plurality of partial feature sets in the group of the plurality of partial feature sets and clustering the collective features.

4. The information processing apparatus according to claim 3, wherein in the selection process, the at least one processor selects, based on the collective features, one of the plurality of partial feature sets included in each of the plurality of clusters, as the at least one of the plurality of partial feature sets which corresponds to the set of pieces of data from which the target data to be provided with the ground truth label is to be selected.

5. The information processing apparatus according to claim 1, wherein in the division process, the at least one processor divides the set of features constituting the feature series into the plurality of partial feature sets by clustering the set of features.

6. The information processing apparatus according to claim 1, wherein in the selection process, the at least one processor selects, based on the number of the plurality of clusters and on the number of pieces of the target data to be provided with the ground truth label, one of the plurality of partial feature sets included in each of the plurality of clusters, as the at least one of the plurality of partial feature sets which corresponds to the set of pieces of data from which the target data to be provided with the ground truth label is to be selected.

7. An information processing method comprising:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series,
the division process, the clustering process, and the selection process being carried out by at least one processor.

8. A non-transitory storage medium storing a program causing at least one processor to carry out:
a division process of dividing, into a plurality of partial feature sets, a set of features constituting a feature series corresponding to each of a plurality of data series;
a clustering process of clustering, into a plurality of clusters, a group of the plurality of partial feature sets which has been obtained from the plurality of data series; and
a selection process of selecting target data to be provided with a ground truth label, from a set of pieces of data which corresponds to at least one of the plurality of partial feature sets included in each of the plurality of clusters and which constitutes at least part of one of the plurality of data series.
